(19) United States
(12) Patent Application Publication
(10) Pub. No.: US 2004/0128901 A1
(43) Pub. Date: Jul. 8, 2004

(54) Fishing rod having adjustable weight device

(76) Inventor: Mu San Chen, Taichung (TW)

Correspondence Address: Mu San Chen, P.O.Box 63-99, Taichung, 406, TW

(21) Appl. No.: 10/336,966

(22) Filed: Jan. 4, 2003

(51) Int. Cl. A01M 1/00

(52) U.S. Cl. 43/1

(57) ABSTRACT

A fishing rod includes a tube for supporting a fishing reel, one or more poles detachably secured to front end of the tube, and a cover detachably secured to the other or rear end of the tube, to adjust the rear end of the tube to different weights, and for allowing the users to spend less energy to rotate or to pull the fishing rod while conducting fishing operations. A spring member and one or more weight members may be selectively received in the tube, to further adjust the rear end of the tube to different weights. The cover may further include a protrusion engaged into the tube. One or more poles may be selectively secured to the front end of the tube to adjust the fishing rod to different lengths.

### BACKGROUND OF THE INVENTION

1. Field of the Invention

The present invention relates to a fishing rod, and more particularly to a fishing rod having adjustable weight device to fish various kinds of fishes.

2. Description of the Prior Art

Various kinds of typical fishing rods have been developed for fishing purposes, and comprise various kinds of standards, types, sizes, lengths, or weights, for fishing various kinds of fishes. However, the various kinds of typical fishing rods each includes a predetermined standard, or type, or length, or weight, and may not be changed to different standards, types, sizes, lengths, or weights, such that the users have to prepare various kinds of fishing rods to conduct different fishing operations, or to fish various kinds of fishes.

For example, the typical fishing rods may include a retractable or telescopic structure for allowing the fishing rods to be retracted to a compact storing status, or to be extended to a working status. However, once the fishing rods have been extended to the working status, the fishing rods may no longer be adjusted to different lengths. In addition, the typical fishing rods may not be adjusted to different weights, and may not be adjusted to different centers of gravity. The users may thus have to spend greater forces or energies to rotate or to move or to pull the fishing rods, and to fight against fishes.

The present invention has arisen to mitigate and/or obviate the afore-described disadvantages of the conventional fishing rods.

### SUMMARY OF THE INVENTION

The primary objective of the present invention is to provide a fishing rod adjustable to different weights for fishing various kinds of fishes.

The other objective of the present invention is to provide a fishing rod adjustable to different lengths for conducting various kinds of fishing operations.

In accordance with one aspect of the invention, there is provided a fishing rod comprising a tube including a first end and a second end, one or more poles detachably secured to the first end of the tube, a fishing reel selectively attached to the tube, and a cover detachably secured to the second end of the tube, to adjust the second end of the tube to different weights, and for allowing the users to spend less energy to rotate or to pull the fishing rod while conducting fishing operations.

A spring member and/or one or more weight members may be alternatively or selectively received in the second end of the tube, to further adjust the second end of the tube to different weights. The cover may further include a protrusion engaged into the second end of the tube.

The tube includes an outer thread formed on the second end thereof, the cover includes an inner thread to thread with the outer thread of the tube, and to detachably secure the cover to the tube.

A coupler may further be used to secure the cover to the second end of the tube, and may include one or more spring blades to engage with the protrusion of the cover. A ferrule may further be provided and threaded with the coupler to force the spring blades to engage with the protrusion of the cover.

A pipe may further be provided and received in the first end of the tube, the poles may be engaged and retained in the pipe with such as force-fitting engagements. The pipe includes one end having an outer peripheral flange extended therefrom and engaged with the tube, to retain the pipe to the tube, and includes one end having a greater inner diameter than that of the other end of the pipe.

A coupler may further be provided to secure the pipe to the first end of the tube, and may include at least one spring blade to engage with the pipe. A ferrule may further be provided and threaded with the coupler to force the spring blade to engage with the pipe. One or more additional poles may further be detachably secured to the first end of the tube.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a fishing rod in accordance with the present invention;

FIG. 2 is a partial exploded view of the fishing rod;

FIG. 3 is a partial cross sectional view illustrating the rear portion of the fishing rod;

FIGS. 4, 5, 6, 7, 8, 9, 10, 11, 12 are partial cross sectional views similar to FIG. 3, illustrating the other weight members to be selectively or changeably attached to the fishing rod;

FIG. 13 is a partial exploded view illustrating the further weight members to be selectively or changeably attached to the fishing rod;

FIG. 14 is a partial plan view illustrating one of the weight members as shown in FIG. 13, to be selectively or changeably attached to the fishing rod;

FIG. 15 is a partial exploded view illustrating various pole members to be selectively or changeably attached to the fishing rod;

FIG. 16 is a partial cross sectional view illustrating one of the pole members as shown in FIG. 15, to be selectively or changeably attached to the fishing rod; and

FIG. 17 is a partial exploded view illustrating the other arrangement of the fishing rod.

### DETAILED DESCRIPTION OF THE PREFERRED EMBODIMENT

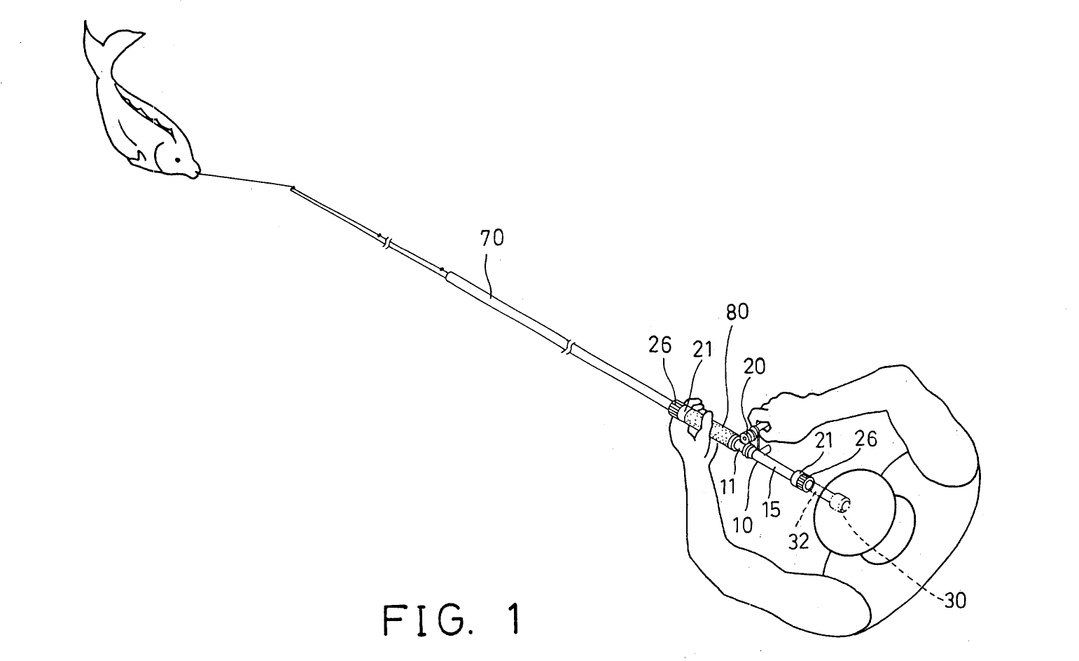

Referring to the drawings, and initially to FIGS. 1-3, a fishing rod in accordance with the present invention comprises a tubular or longitudinal tube 10 including a middle portion 11 having a fishing reel 20 attached thereto, and including a bore 12 formed therein, and including two ends each having an outer thread 14 formed thereon and each may further includes an inner thread 13 formed therein (FIGS. 13, 17).

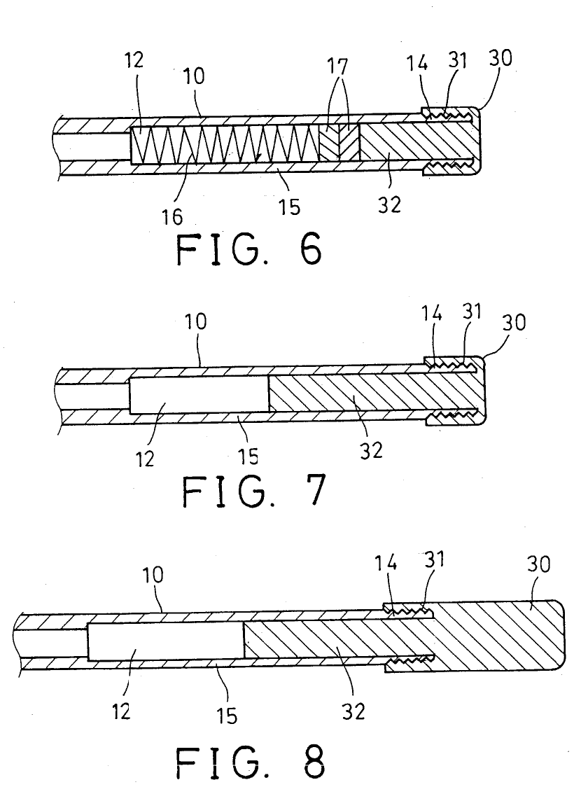

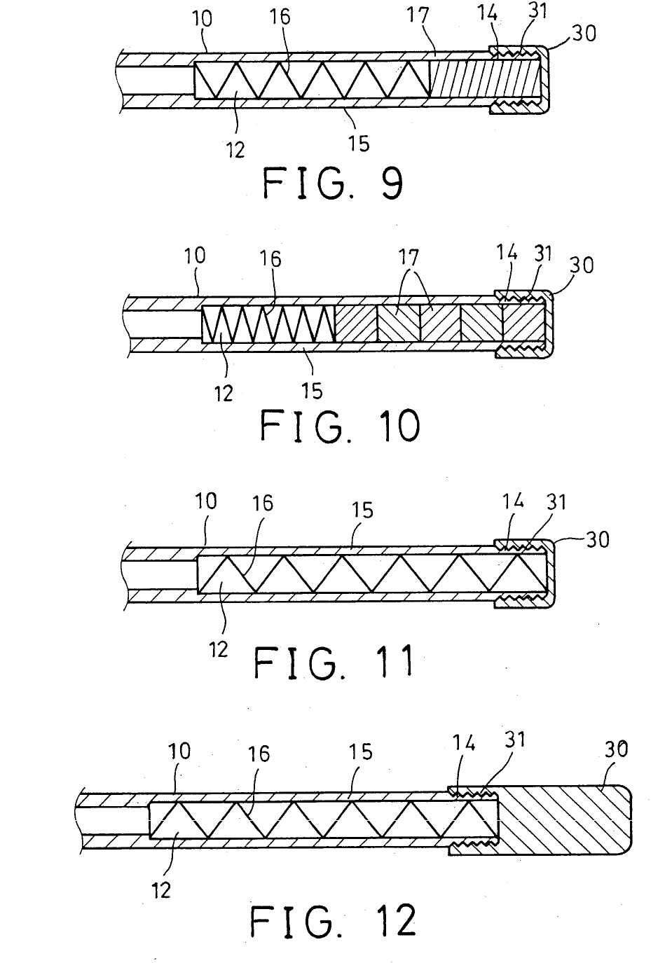

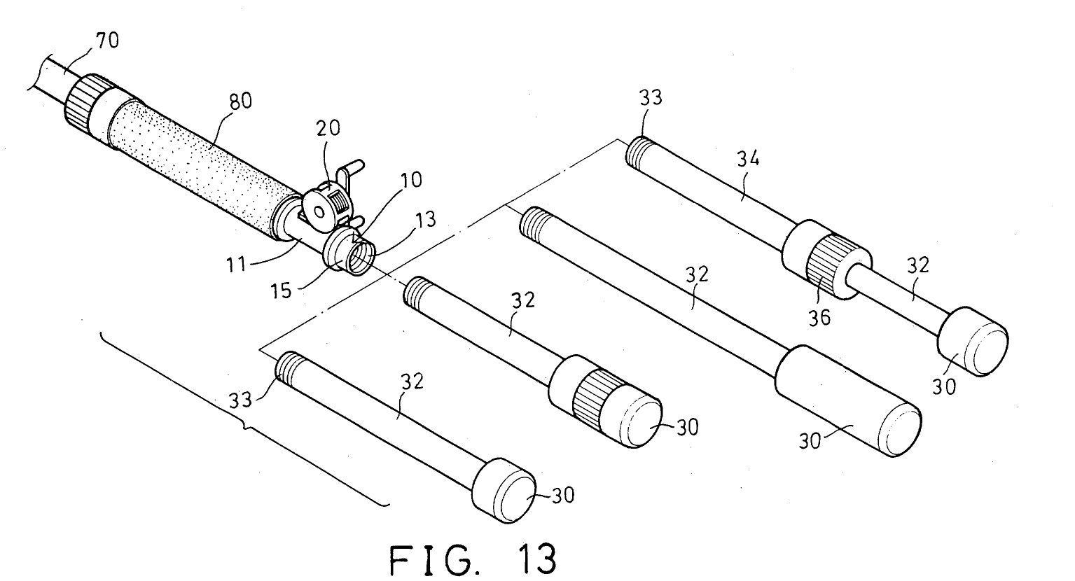

A spring 16 and/or one or more weight members 17 may be engaged into and received within the bore 12 of the rear portion 15 of the tube 10, as shown in FIGS. 3-4, 6, and 9-12, to adjust the rear portion 15 of the tube 10 to different weights. One or more covers 30 each may include an inner thread 31 formed therein for threading with the outer thread 14 of the tube 10, to retain the spring 16 and the weight members 17 within the tube 10, best shown in FIGS. 6-12.

The covers 30 themselves may each further include an protrusion 32 extended therefrom and engaged into the bore 12 of the tube 10, as shown in FIGS. 6-8, and/or engaged with the weight members 17 (FIG. 6). The covers 30 may be made of different metal materials, and may be formed into different lengths and/or weights and/or shapes, as shown in FIGS. 8, 12-14.

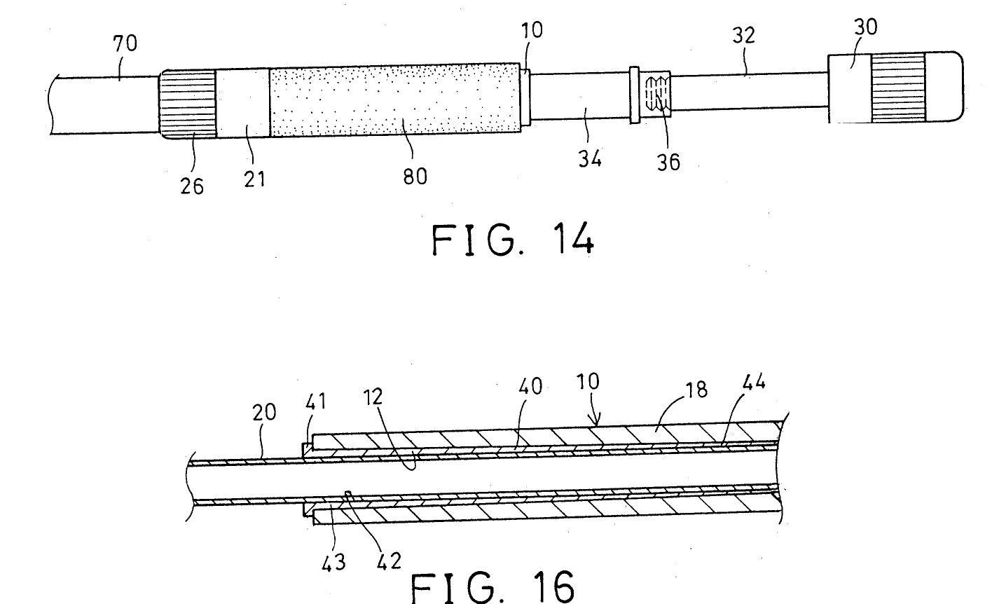

The protrusions 32 of the covers 30 and/or the covers 30 themselves may thus be used or formed as weight members to adjust the rear portion 15 of the tube 10 to different weights. The protrusions 32 of the covers 30 may each include an outer thread 33 formed in one end thereof (FIG. 13) for threading with the inner thread 13 of the tube 10. An extension 34 (FIGS. 13, 14) may further be provided and coupled between the tube 10 and the protrusion 32 of the cover 30 with a coupler 36 and/or with such as threading engagements.

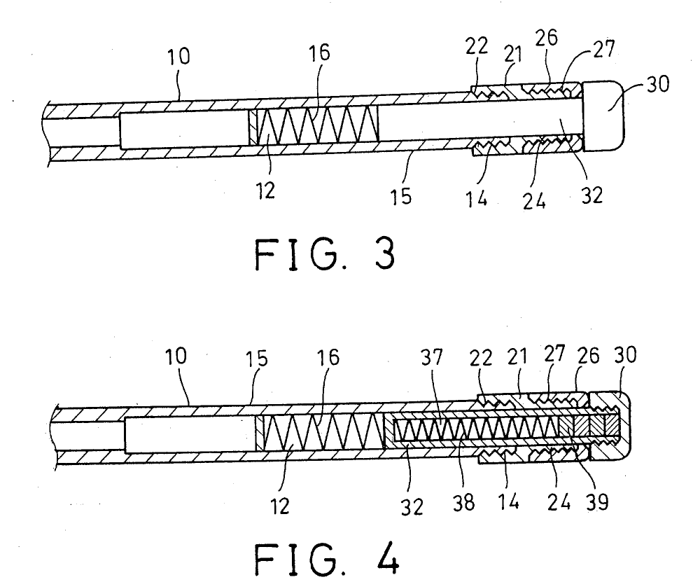

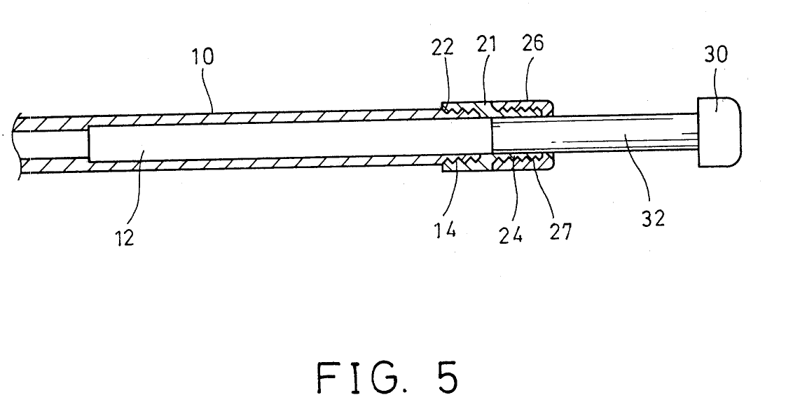

As shown in FIG. 4, the protrusion 32 of the cover 30 may further include a chamber 37 formed therein for receiving a spring member 38 and/or one or more weight members 39 therein, in order to further selectively adjust the rear portion 15 of the tube 10 to different weights.

As shown in FIGS. 1-4, a coupler 21 may further be provided, and includes an inner thread 22 formed in one end thereof for threading with the outer thread 14 of the rear portion 15 of the tube 10, and an outer thread 23 formed on the other end thereof, and one or more spring blades 24 formed or provided on the other end thereof.

A ferrule 26 includes an inner thread 27 formed therein for threading with the outer thread 23 of the coupler 21, in order to force the spring blades 24 to engage with the extension 32 of the cover 30, and so as to selectively lock the cover 30 to the tube 10. With the ferrule 26 and the coupler 21, the cover 30 is not required to be directly threaded or coupled or secured to the tube 10; i.e., the cover 30 may also be selectively secured to the tube 10 with the ferrule 26 and the coupler 21.

Similarly, another coupler 21 may further be provided, and includes an inner thread 22 formed in one end thereof for threading with the outer thread 14 of the front portion 18 of the tube 10, and one or more spring blades 24 formed or provided on the other end thereof, and an outer thread 23 formed on the other end thereof, for threading with the inner thread 27 of the ferrule 26, and for allowing the coupler 21 and the ferrule 26 to be selectively attached to the front portion 18 of the tube 10.

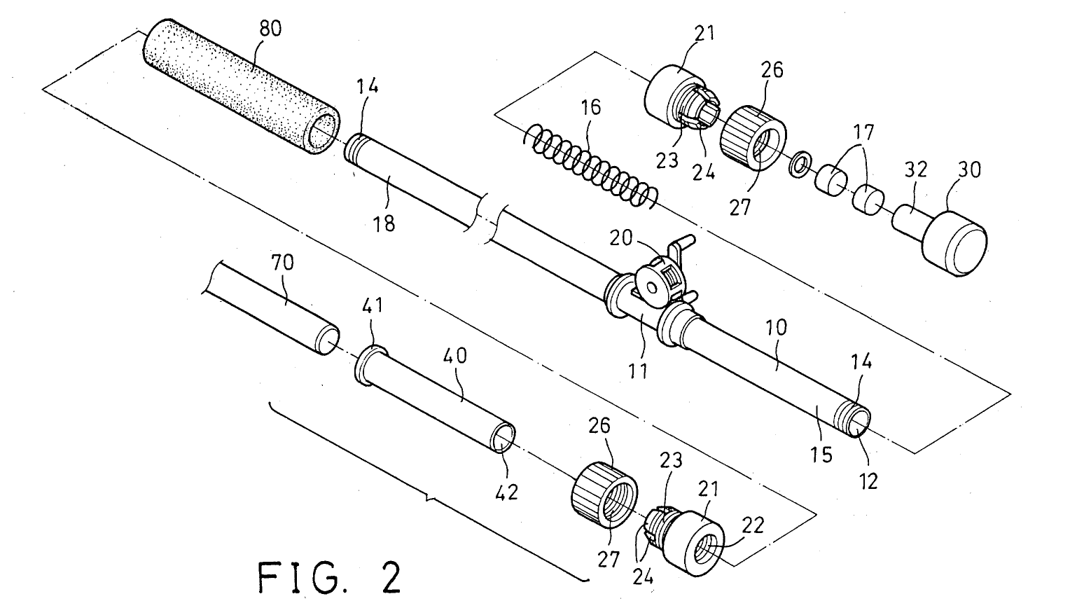

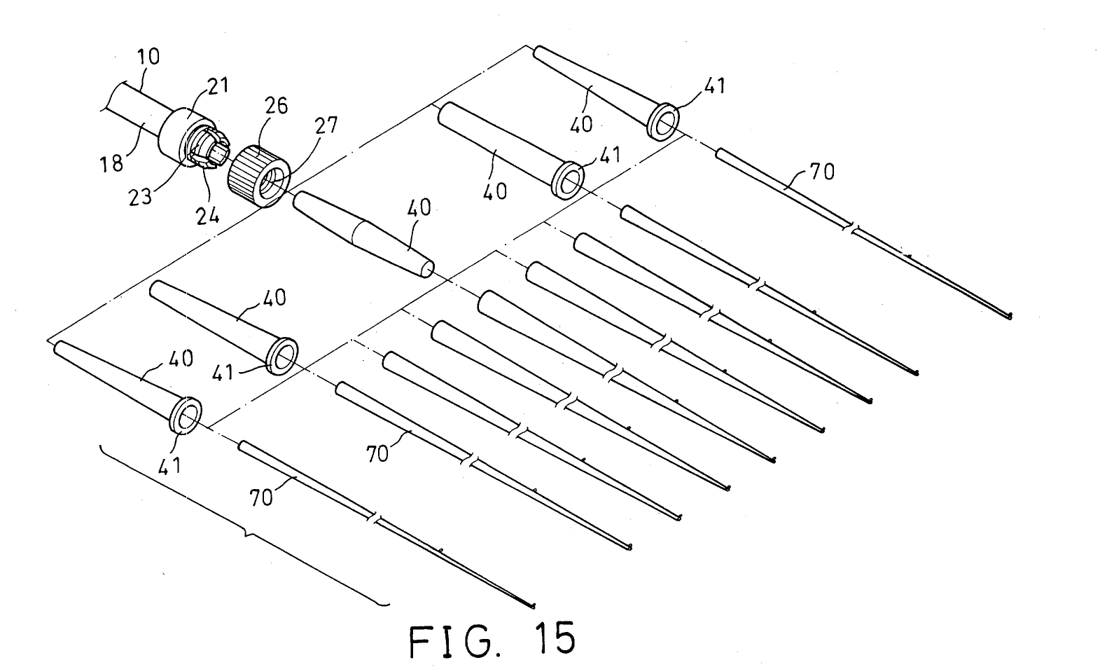

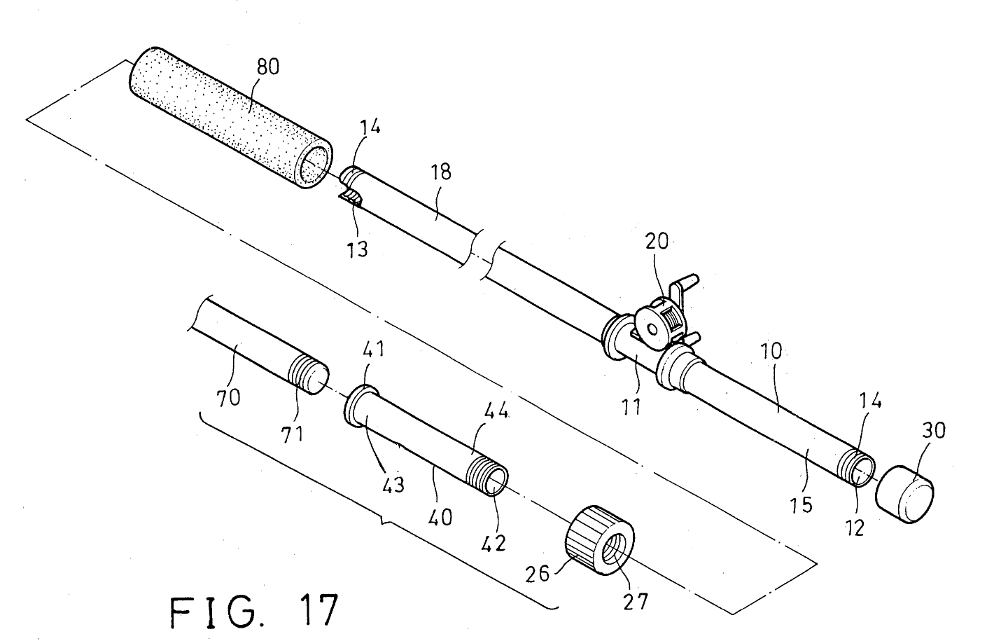

As shown in FIGS. 2, 15-17, a number of pipes 40 may be selectively or changeably engaged into the front portion 18 of the tube 10, and each may include an outer peripheral flange 41 extended outwardly from one end thereof, to engage with the tube 10 (FIG. 16), and to retain the pipes 40 to the tube 10. The pipes 40 each includes a bore 42 formed therein for selectively or changeably receiving various poles 70 therein.

It is preferable that the bore 42 of each pipe 40 includes a greater inner diameter formed or provided in one end, such as the outer end 43 of the pipe 40, and a smaller inner diameter formed or provided in the other end, such as the inner end 44 of the pipe 40, for allowing the poles 70 of different or various outer diameters to be changeably engaged into and secured to the pipes 40, with such as force-fitting engagements.

Alternatively, as shown in FIG. 17, the poles 70 may include an outer thread 71 provided on one end thereof to thread with the inner thread 13 of the tube 10, and to secure the poles 70 to the tube 10. The poles 70 may also be secured to the pipes 40 or the tube 10 with the ferrule 26.

In operation, the spring 16 and/or the weight members 17, and/or the protrusions 32 of the cover 30 may be selectively or changeably attached to the rear portion 15 of the tube 10, in order to adjust the rear portion 15 of the tube 10 to different weights. When the rear portion 15 of the tube 10 is changed to greater weights, the users may spend less energy to rotate or to pull the fishing rod.

The poles 70 may be selectively or changeably attached to the front portion 18 of the tube 10 directly, or indirectly with the pipes 40, and/or with the coupler 21 and the ferrule 26, in order to change or to adjust the fishing rod to different lengths, for allowing the users to conduct different or various fishing operations. A resilient or soft sleeve 80 may further be provided and engaged onto the front portion 18 of the tube 10, for allowing users to comfortably grasp the tube 10.

Accordingly, the fishing rod In accordance with the present invention is adjustable to different weights for fishing various kinds of fishes, and/or adjustable to different lengths for conducting various kinds of fishing operations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fishing rod comprising:
a tube including a first end and a second end,
a first pole detachably secured to said first end of said tube,
a fishing reel selectively attached to said tube, and
a cover detachably secured to said second end of said tube, to adjust said second end of said tube to different weights.

2. The fishing rod as claimed in claim 1 further comprising a spring member received in said second end of said tube.

3. The fishing rod as claimed in claim 1 further comprising at least one weight member received in said second end of said tube.

4. The fishing rod as claimed in claim 1, wherein said cover includes a protrusion engaged into said second end of said tube.

5. The fishing rod as claimed in claim 1, wherein said tube includes an outer thread formed on said second end thereof, said cover includes an inner thread to thread with said outer thread of said tube, and to detachably secure said cover to said tube.

6. The fishing rod as claimed in claim 1 further comprising a coupler to secure said cover to said second end of said tube.

7. The fishing rod as claimed in claim 6, wherein said cover includes a protrusion engaged through said coupler, said coupler includes at least one spring blade to engage with said protrusion of said cover.

8. The fishing rod as claimed in claim 7 further comprising a ferrule threaded with said coupler to force said at least one spring blade to engage with said protrusion of said cover.

9. The fishing rod as claimed in claim 1 further comprising a pipe received in said first end of said tube, said first pole being engaged and retained in said pipe.

10. The fishing rod as claimed in claim 9, wherein said pipe includes a first end having an outer peripheral flange extended therefrom and engaged with said tube, to retain said pipe to said tube.

11. The fishing rod as claimed in claim 9, wherein said pipe includes a first end having a greater inner diameter than that of a second end thereof.

12. The fishing rod as claimed in claim 9 further comprising a coupler to secure said pipe to said first end of said tube.

13. The fishing rod as claimed in claim 12, wherein said coupler includes at least one spring blade to engage with said pipe.

14. The fishing rod as claimed in claim 13 further comprising a ferrule threaded with said coupler to force said at least one spring blade to engage with said pipe.

15. The fishing rod as claimed in claim 1 further comprising at least one second pole detachably secured to said first end of said tube.
